(19) United States
(12) Patent Application Publication
(10) Pub. No.: US 2017/0357099 A1
(43) Pub. Date: Dec. 14, 2017

(54) Overlay Display

(71) Applicant: Apple Inc., Cupertino, CA (US)

(72) Inventors: Matthew E. Last, Santa Clara, CA (US); Malcolm J. Northcott, Felton, CA (US)

(21) Appl. No.: 15/524,615

(22) PCT Filed: Oct. 30, 2015
(86) PCT No.: PCT/US2015/058437

§ 371 Date: May 4, 2017

Related U.S. Application Data
(60) Provisional application No. 62/075,833, filed on Nov. 5, 2014.

(51) Int. Cl. G02B 27/22; G02B 5/20; G02B 27/01; G09G 3/00; H04N 13/04

(52) U.S. Cl. CPC G02B 27/2278; G09G 3/003; H04N 13/0404; G02B 27/0101; G02B 5/208; H04N 13/0459; H04N 13/0497; G02B 2027/0112; G09G 2354/00; G02B 2027/014

(57) ABSTRACT

Some embodiments provide a system which includes a layered transparent surface which includes a UV absorption layer configured to be located between a user environment and an external environment and a phosphor layer configured to be located between the user environment and the UV absorption layer. An image projection system can project an ultraviolet image upon the phosphor layer, which can generate a visual image based on a fluorescent reaction of the phosphor layer to the ultraviolet image which can be perceived by a user in the user environment. The image projection system can include a plurality of image projection systems which can project separate images on separate projection fields, which can result in the phosphor layer generating an image which can be perceived by a user, in the user environment, as a stereoscopic image.

### BACKGROUND

In many situations, a graphical overlay can be provided on a scene that is perceived through a transparent surface, including a window. A graphical overlay can provide information to an observer. In some cases, a graphical overlay is used in a vehicle, where a graphical overlay can be perceived by an occupant of the vehicle and provides information relevant to the vehicle, including vehicle speed. Such information can be provided on the windscreen such that the information can be perceived by an operator of the vehicle, including a driver, near the line of sight of the operator as the operator observes the environment through which the operator navigates the vehicle, including an oncoming roadway.

In some cases, the graphics displayed should be able to overlay certain objects seen through the windscreen. A good example would be highlighting the position of a pedestrian, particularly in the dark or in inclement weather. In some cases, a graphical overlay is used in aircraft, where it is known as a heads up display, or “HUD.” In aircraft, the HUD is used to assist the pilot in takeoff and landing, and in military aircraft it assists with weapons targeting and battle planning. There are several types of HUDS, discussed below.

In some cases, a HUD includes a small partially-silvered beam splitter, or some other type of beam splitter, which is located between a user and a transparent surface, including a wind screen, and allows the user to perceive a display that is hidden below the beam splitter. The display may be a traditional projector, a laser scanner, a light-field projector that can project a virtual image out to a predefine distance of set of distances, etc.

In some cases, a HUD includes a head mounted display, where a small beam splitter or diffractive beam director is placed directly in front of one or both of the user's eyes. Images are then reflected from this beam splitter into the user's eyes. This system can provide text overlay, a full three dimensional display, etc. By augmenting the head mounted display with a head tracker, the graphics may be made to appear static with respect to the outside world.

In some cases, a HUD includes a fully simulated display, which can include the Oculus Rift© system. This type of display may also be realized by projecting images on a screen that surrounds the user, which can be particularly effective if light field projectors are used to produce image depth. In this type of display, if set up to overlay images on the outside world, cameras relay images of the outside world to the user. The display is completely opaque to outside light, and everything the user sees, including the outside world and overlays, is artificially generated. This type of display allows for complete control over the user experience.

### SUMMARY OF EMBODIMENTS

Some embodiments provide a method which includes producing overlay graphics and other display information on a transparent window without disturbing the view of a scene seen through the window.

Some embodiments provide a system which includes a layered transparent surface which includes an ultraviolet (“UV”) absorption layer configured to be located between a user environment and an external environment and a phosphor layer configured to be located between the user environment and the UV absorption layer. An image projection system can project an ultraviolet image upon the phosphor layer, which can generate a visual image based on a fluorescent reaction of the phosphor layer to the ultraviolet image which can be perceived by a user in the user environment. The system can include multiple separate image projection systems which can project visual images over at least partially separate projection fields on the layered transparent surface. The separate portions can at least partially overlap. The image projection system can include a plurality of image projection systems which can project separate images on separate projection fields, which can result in the phosphor layer generating an image which can be perceived by a user, in the user environment, as a stereoscopic image.

Some embodiments provide a method which includes generating a UV image of a graphical overlay display and projecting the UV image onto a surface, where the surface includes a UV absorption layer and at least one fluorescent layer, including one or more phosphors, located between the projected image and the UV absorption layer. The UV image is projected at the surface, such that the UV image projected onto the surface activates one or more phosphors and generates a visual display, perceptible to a user, of the graphical overlay display. The at least one fluorescent layer can include multiple different phosphors with multiple different corresponding activation wavelengths and multiple different corresponding activation visual wavelengths, colors, etc., and the UV image can include one or more patterns projected at the one or more wavelengths, such that the multiple phosphors provide a multi-color display based on a projected UV image which includes various image portions projected at various different UV wavelengths.

### BRIEF DESCRIPTION OF THE DRAWINGS

FIG. 1 illustrates an overlay display system, according to some embodiments.

FIG. 2 illustrates an overlay display system that provides color images using multiple phosphor layers, according to some embodiments.

FIG. 3 illustrates an overlay display system that provides color images using phosphors arranged in multiple clusters, according to some embodiments.

FIG. 4 illustrates an overlay display system with multiple projectors, according to some embodiments.

FIG. 5 illustrates an overlay display system for providing a stereoscopic display, according to some embodiments.

FIG. 6A illustrates a flowchart of a method for providing a surface configured to provide a graphical overlay display to a user based on a projected UV image onto the surface, according to some embodiments.

FIG. 6B illustrates a flowchart of a method for providing a graphical overlay display to a user, according to some embodiments.

FIG. 7 illustrates an example computer system that may be configured to include or execute any or all of the embodiments described above.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION

Some embodiments include an overlay display system which provides the display of information on transparent surfaces, which can include windows, without significantly degrading the visible image of an environment seen through the transparent surfaces. The system can also be constructed without introducing elements that significantly increase scattering of light off the window.

In some embodiments, the overlay display system includes a transparent surface, which can include a “window,” which establishes at least a portion of a boundary between an interior cabin of a vehicle and an external environment. The window can include an interior surface facing into the cabin and an external surface facing into the external environment. The window can include a windscreen. The window, in some embodiments, is configured to prevent UV radiation from penetrating to the cabin interior from the external environment. The window can be at least partially treated to configure the window; such treating can include adding a UV absorption film to an interior surface of the window, formulating the material comprising at least a portion of the window, including one or more forms of glass, to absorb the UV wavelengths, some combination thereof, etc.

In some embodiments, a film, layer, etc. added to the window can include optically-transparent, UV activated phosphors. Such a film, layer can be referred to as a fluorescent layer. The film can be laminated to the interior side of the window. In some embodiments, phosphors are incorporated in an interior layer of the window itself The phosphors on the interior side of the window can be configured to display an image based on a UV light beam projected from a UV light source of a correct wavelength onto the interior surface of the window to activate the phosphor. Due to the UV absorption properties of the window, the phosphor may not be activated by the sun, or any other external UV source. The phosphors are can include particular phosphors which are transparent at visible wavelengths and dispersed finely enough to avoid scattering at visible wavelengths of light.

The UV light beam projected onto the interior side of the window can include a projection of a beam pattern corresponding with an image, such that the phosphors in the interior surface of the window are activated by the UV light beam in a pattern which causes the image to be perceived by an occupant of the cabin interior as an overlay on the window. Internal to the vehicle, the UV light beam can be imperceptible to the occupants, and can impart a reduced effect upon the internal illumination of the vehicle cabin, relative to other sources of illumination. Such reduced illumination can include negligible imparted effect upon the internal illumination. In some embodiments, such reduced effect on internal illumination can enable an occupant's night vision acuity, including a driver's night vision acuity, to be maintained during nighttime, low-light, etc. conditions.

In some embodiments, the window includes two or more phosphors, and the system can provide a multicolor display perceptible to an occupant based on the window including the two or more phosphors. For example, a red-green-blue (“RGB”) image can be fabricated based on phosphors, included in the window, that radiate in the Red, Green, and Blue areas of the visible spectrum. The red, green, and blue phosphors can be selected such that they are each activated by different UV wavelengths. Separate phosphors can be included in separate fluorescent layers applied to the surface. As a result, a 3-color UV image projection system can produce a three color RGB visible image based on projecting a UV light beam onto the window, where the light beam includes at least three separate light patterns at three separate wavelengths corresponding to the activation wavelengths of the three separate phosphors in the window. In another example, the RGB phosphors can be spatially segregated on the window in RGB clusters, such that a single laser directed to a particular cluster can result in the window generating red, green, or blue light depending on which phosphor region is activated by the laser light. In such a case, an image can be built up in a similar manner to the way an image is produced on a color cathode ray tube (“CRT”).

The image projection system, in some embodiments, includes a projector, including a digital light processing (“DLP”) projector, configured to work at a particular set of one or more UV wavelengths. In some embodiments, a raster scanning system can sweep one or more laser beams across the region of interest building up the image by raster scanning. In another example, one or more lasers could be scanned on the display using a vector scanning algorithm. It should be apparent that any other method of producing a 2 dimensional image could be used to create the required UV image.

In some embodiments, the overlay display system includes one or more non-transparent surfaces. In fact it would be possible to have graphics seamlessly transition from glass areas to opaque areas without interruption. On an opaque surface it would be possible to place the phosphor behind a lenticular array. If this phosphor were then addressed with an array of UV lasers, it would be possible to generate a light field display that would be able to simulate parallax and place objects at a virtual range. This would work for display purposes on a window, but the lens let array would tend to distort images seen through the window.

In some embodiments, an image projection system which includes a single projector can be limited in projecting an image across a large area of curved glass. For example, some areas of the window may have an obstructed line of sight to the projector. In some embodiments, such limitation is overcome in a system which comprises multiple projectors that project images on overlapping tiles of the phosphor substrate included in the window. One or more cameras pointing at the window can provide enough information allow a system of overlapping projectors to adjust their display content and distortion correction to generate a seamless single view to the observer. Distortion correction can be performed by distorting the geometry of the projected image to allow for the curved surface of the window, and to correct for viewing angle/distance variations from the perspective of the operators. Distortion correction can be improved by using additional cameras to monitor the position of the operator in order to refine the distortion correction.

In some embodiments, the overlay display system is configured to mitigate UV safety issues associated with the use of UV light beams. For example, the selected wavelengths used, based on the activation wavelengths of selected phosphors, can include long wave UV (“UVA”) light, including approximately 400 nm wavelength light. A system which projects long wavelength UV light can result in reduced potential danger of the UV illumination, relative to systems which project shorter-wavelength UV light. In another example, the system can include one or more image projection systems (“projectors”) which are placed, oriented, etc. relative to the interior cabin such that the capacity of an operator to look directly into the projector aperture is reduced, minimized, mitigated, negated, etc. As a result, the UV light which can pass into the interior cabin, and thus be directly observed by an occupant of the cabin, can be at least partially restricted to scattered UV light, scattered UVA light, etc. which can pose a reduced hazard relative to direct UV light, direct UVA light, etc.

In some embodiments, the overlay display system is configured to augment a natural view of the eternal environment by an occupant of the cabin interior, provide a certain amount of particular information, including safety data, some combination thereof, etc. to an interior cabin occupant. In some embodiments, the system is configured to display sparse graphics, such that the view by the occupants of the external environment through the one or more windows on which graphics can be displayed is not significantly affected. Sparse graphics can result in reduced UVA light in most of the projector field. If the projector is a laser scanner, this means that most of the time the scan laser will be turned off or emitting at very low power.

In some embodiments, where an image is formed over opaque surfaces, the surface can comprise a UV absorption layer under the phosphor. Such a UV absorption layer can be a coating on the surface. The UV absorption layer can reduce scatter of UV light into the interior cabin, can improve image quality by cutting down diffuse illumination caused by scattered UV light, some combination thereof, etc.

In some embodiments, the system can be included in a vehicle and can be configured to provide graphical displays to one or more particular interior occupants of the vehicle cabin via one or more surfaces in the cabin, including one or more windows, including the windscreen or side windows of a vehicle. Graphical displayed provided via one or more windows can provide helpful information without degrading an occupant's view of the road.

The overlay display system can provide various advantages, relative to other systems, including various HUD designs. For example, where a HUD includes a beam splitter, the beam splitter can be of limited size, which can limit the field of view of the user. As a result, the utility of such a HUD can be at least partially dependent upon the size and corresponding gaze point of the user. In addition, the overlay provided by the beam splitter can be limited, where, if a user is looking to the side, there may not be enough field of view to allow the user to see the graphics. This could occur, for instance, if the driver of a car was following a curve in the road. In addition, the beam splitter can result in reduced intensity of the light from the outside scene, and thus may impair visual acuity in challenging conditions, including nighttime conditions, low-light conditions, etc. In addition, the beam splitter may produce annoying reflections on the windscreen. For example, with some angles of the sun, significant sunlight may be reflected off the back to the beam splitter into the user's line of sight through the windscreen. In another example, in a head mounted display a small beam splitter or diffractive beam director is placed directly in front of one or both of the operators eyes, the head mounted display requires the user to wear a display, and some devices are large and uncomfortable to wear for extended periods. In addition, the beam splitter mirrors and associated optics are delicate and must be kept clean in order to function correctly. In addition, scatter from multiple optical surfaces or off the diffractive beam directors can degrade the transmitted image quality. In addition, the displays often have to be adjusted to accommodate each user, so may not be readily interchangeable. In another example, in a fully simulated display, including the Oculus Rift, a head mounted version of this type or display requires bulky optics and can be uncomfortable to wear for extended periods of time. In addition, for activities such as driving, relaying all information through electronics could render the system more prone to failure. In addition, the fidelity of the generated images may be significantly lower than would be seen by direct viewing. In addition, the camera image capture and display pipeline may result in significant time lag compared with direct viewing, which could lead to a degradation of control activities like driving. Furthermore, it is not clear that the public would accept the proliferation of cars and trucks that use this type of display technology as the primary driver input.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### Overlay Display System

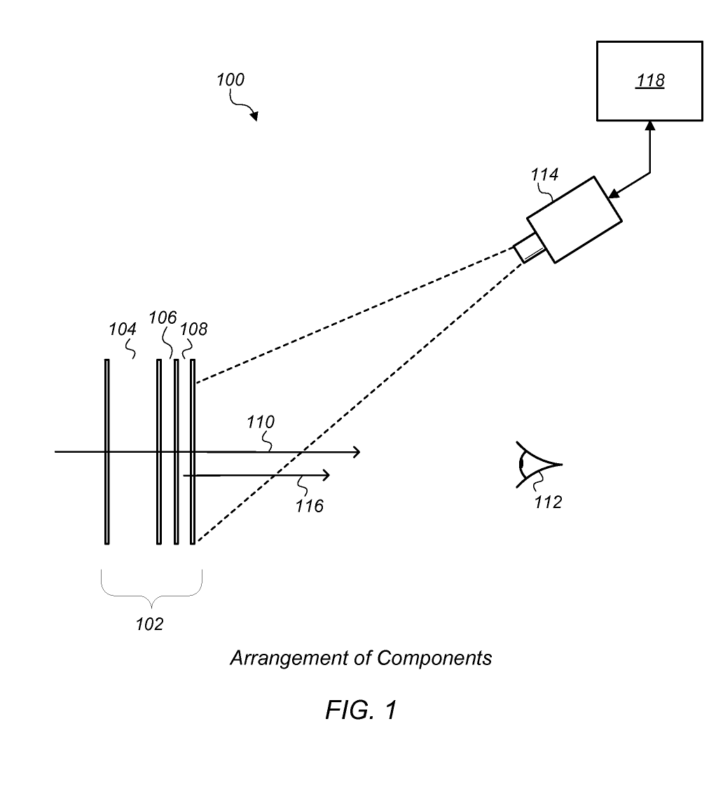

FIG. 1 illustrates an overlay display system 100, according to some embodiments. In the example embodiment, a first layer of a surface 102 comprises glass 104. The glass 104 can be composed of multiple layers. For example, the glass 104 can comprise two or more outer glass layers surrounding an inner polymer layer. The surface 102 may function as a windscreen, windshield, or any type of window. In other embodiments, the first layer of the surface 102 may be composed of any other suitable transparent material.

UV absorption layer 106 is a second layer of the surface 102 that absorbs UV wavelengths. The UV absorption layer 106 can be laminated on the inside of the glass 104 as illustrated, can be incorporated into the glass 104 construction itself, or some combination thereof UV fluorescent layer 108 is a third layer of the surface 102 that contains UV fluorescent components. The UV fluorescent components (“phosphors”) can be incorporated into the structure of the glass 104, provided that the UV absorption layer 106 is between the UV fluorescent layer 108 and the external surface of the glass 104.

External light 110 is a light beam ray coming from outside of the glass 104 (the “external environment”), and transiting to an observer's eye 112. A projector 114 projects a UV image onto the UV fluorescent layer 108, also referred to herein as the “phosphor layer” of the surface. Display light 116 is light from the fluorescent layer 108 propagating towards the observer's eye 112, such that the observer perceives a visual image corresponding to the UV image projected by the projector 114. The display light 116 comprises one or more visual wavelengths based at least in part upon activation of one or more phosphors in the UV fluorescent layer 108. The activation of the phosphors in the UV fluorescent layer 108 is caused by projecting the UV image from the projector 114 onto the UV fluorescent layer 108. The overlay display system 100 can be controlled by a control system 118 communicatively coupled to the projector 114, where the control system 118 can be implemented by one or more computer systems.

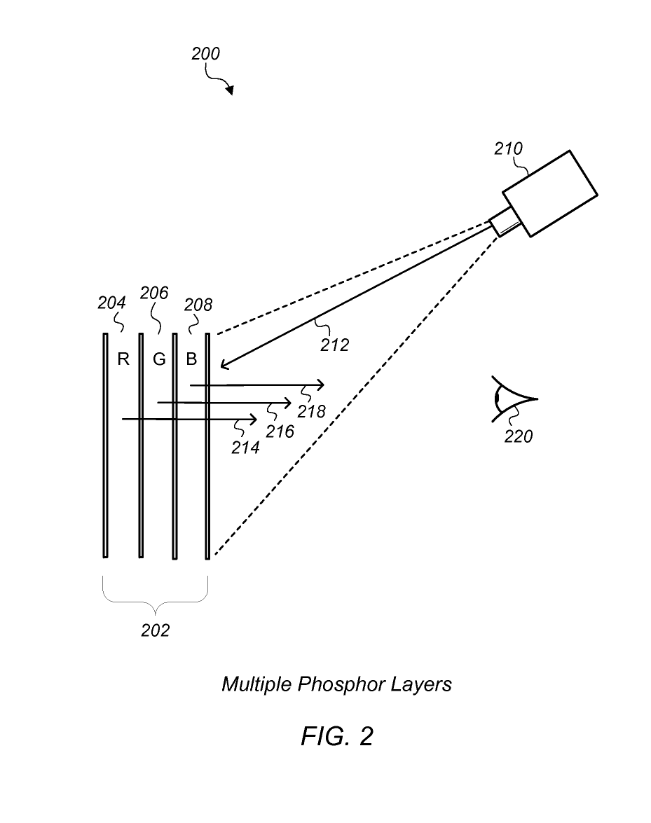

FIG. 2 illustrates an overlay display system 200 that provides color images using multiple phosphor layers, according to some embodiments. A UV fluorescent layer 202 comprises a red fluorescent layer 204, a green fluorescent layer 206, and a blue fluorescent layer 208. The UV fluorescent layer 202 may be applied to any suitable surface, such as the UV absorption layer 106 or the glass 104 of FIG. 1.

The red fluorescent layer 204 contains phosphors with an activation wavelength that corresponds to a first UV wavelength. When the projector 210 projects a light beam 212 onto the fluorescent layer 202 that includes the first UV wavelength, the red fluorescent layer 204 generates visible red light 214. The green fluorescent layer 206 contains phosphors with an activation wavelength that corresponds to a second UV wavelength. When the projector 210 projects a light beam 212 that includes the second UV wavelength, the green fluorescent layer 206 generates visible green light 216. The blue fluorescent layer 208 contains phosphors with an activation wavelength that corresponds to a third UV wavelength. When the projector 210 projects a light beam 212 that includes the third UV wavelength, the blue fluorescent layer 208 generates visible blue light 218. Although the example embodiment shows three fluorescent layers, in other embodiments the overlay display system 400 may include any other number of fluorescent layers, where each layer comprises one or more phosphors with a particular activation wavelength that corresponds to a particular UV wavelength.

The projector 210 can project at least three separate UV light patterns onto the UV fluorescent layer 202, where each UV light pattern has wavelengths that respectively correspond to the activation wavelengths for the red fluorescent layer 204, the green fluorescent layer 206, and the blue fluorescent layer 208. In some embodiments, each UV light pattern may be projected at different light intensities. Thus, the projector 210 can produce a three color RGB image visible by an observer's eye 220 based on projecting the UV light beam 212 onto the fluorescent layer 202, where the UV light beam 212 includes three separate UV light patterns.

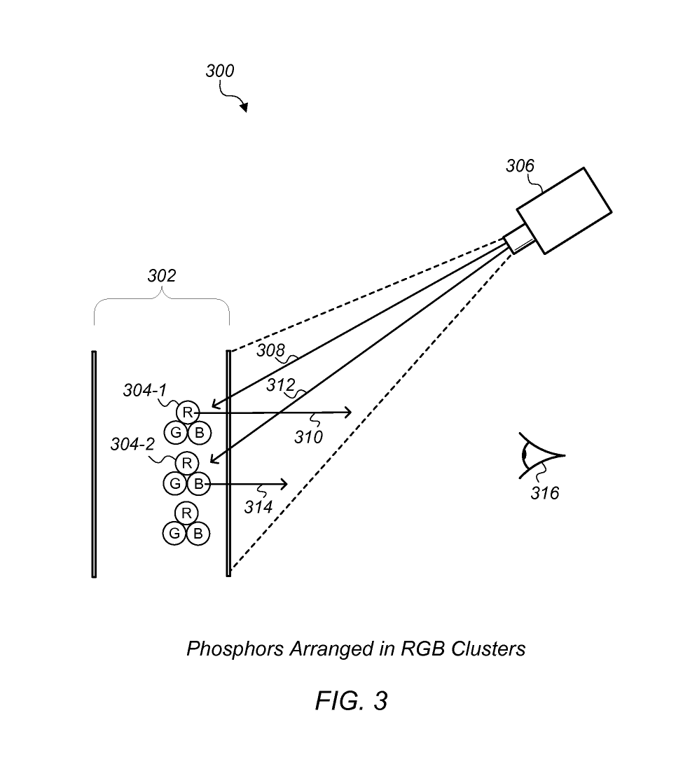

FIG. 3 illustrates an overlay display system 300 that provides color images using phosphors arranged in multiple clusters, according to some embodiments. A UV fluorescent layer 302 comprises multiple RGB clusters 304. The UV fluorescent layer 302 may be applied to a surface, such as the UV absorption layer 106 or the glass 104 of FIG. 1.

Each RGB cluster 304 includes a red phosphor region, a green phosphor region, and a blue phosphor region. The red phosphor region contains phosphors with an activation wavelength that corresponds to a first UV wavelength, the green phosphor region contains phosphors with an activation wavelength that corresponds to a second UV wavelength, and the blue phosphor region contains phosphors with an activation wavelength that corresponds to a third UV wavelength. When the projector 306 projects a light beam, such as a laser, onto a particular RGB cluster, the RGB cluster generates either red, green, or blue light, depending on the UV wavelength of the light beam.

For example, when the projector 306 directs a first laser 308 to RGB cluster 304-1, the red phosphor region of the RGB cluster 304-1 is activated because the UV wavelength of the first laser 308 corresponds to the activation wavelength of the phosphors in the red phosphor region of the RGB cluster 304-1. Therefore, the RGB cluster 304-1 generates red light 310. As another example, when the projector 306 directs a second laser 312 to RGB cluster 304-2, the blue phosphor region of the RGB cluster 304-2 is activated because the UV wavelength of the second laser 312 corresponds to the activation wavelength of the phosphors in the blue phosphor region of RGB cluster 304-2. Therefore, the RGB cluster 304-1 generates blue light 314. A similar process may occur to cause the green region of the RGB cluster 304-1 or 304-2 to generate green light. Therefore, in the example embodiment, an image visible to an observer's eye 316 can be generated in a manner similar to the generation of an image by a CRT.

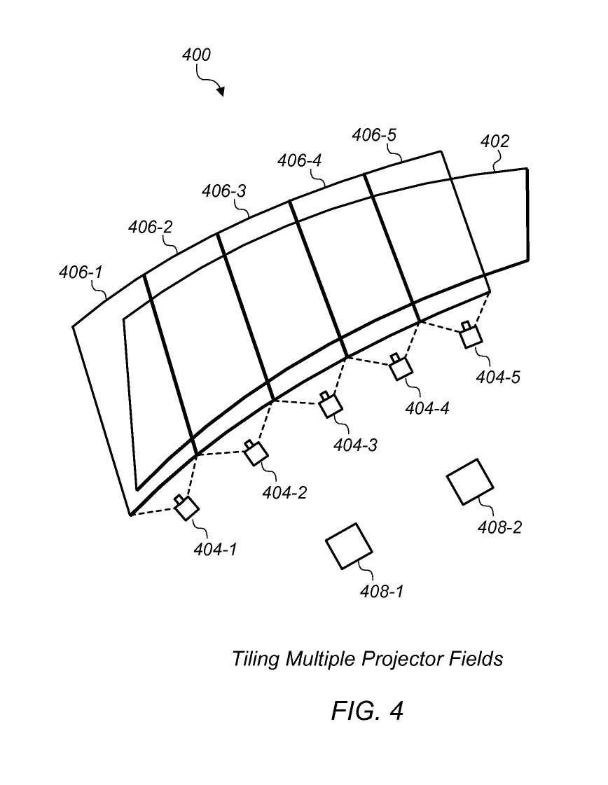

FIG. 4 illustrates an overlay display system 400 with multiple projectors, according to some embodiments. Surface 402 is a windscreen or other transparent surface configured to provide a display, such as the surface 102 of FIG. 1. Each of the projectors 404 project UV images within a corresponding projection field 406. The fields 406 may form a series of tiles, where each tile at least partially covers the surface 402. As shown, the field 404-1 covers areas beyond the surface. Some areas of the surface may not be covered by a field 406, such as the area of the surface 402 to the right of the field 404-5. Although the example embodiment shows five projectors, in other embodiments the overlay display system 400 may include any other number of projectors 404.

In some embodiments, two or more of the fields 406 overlap another field 406. For example, a portion of the field 406-1 may overlap with a portion of the adjacent field 406-2. The overlay display system 400 may use input from camera 408-1 and camera 408-2 to determine an amount of overlap of each of the fields 406. In response to determining the amount of overlap of one or more of the fields 406, the overlay display system 400 may cause one or more corresponding projectors 404 to adjust the one or more fields. For example, the overlay display system 400 may adjust the size or location of the field 406-1 and/or the field 406-2 reduce the overlap area or to cause approximately no overlap. Thus, in some embodiments, the overlay display system 400 may seamlessly knit the projection fields 406 into a seamless whole projection field. In other embodiments, the overlay display system 400 may include any other number of cameras 408.

In some embodiments, the overlay display system 400 uses input from the cameras 408 to determine an amount of distortion of images projected onto the surface 402 by one or more of the projectors 404. The distortion may be caused by curvature of the surface 402. In order to eliminate or reduced the distortion of the images, the overlay display system 400 may cause one or more of the projectors 404 to adjust one or more corresponding fields 406 based on the amount of distortion of projected images. Based on the determined amount of distortion, the overlay display system 400 can use the determined image distortion to correct for image distortion from any view point that can be projected from the views of the cameras 408. In some embodiments, the overlay display system 400 corrects for determined image distortion based at least in part upon determining the spatial geometry of the projectors 404 and projection surfaces of the fields 406.

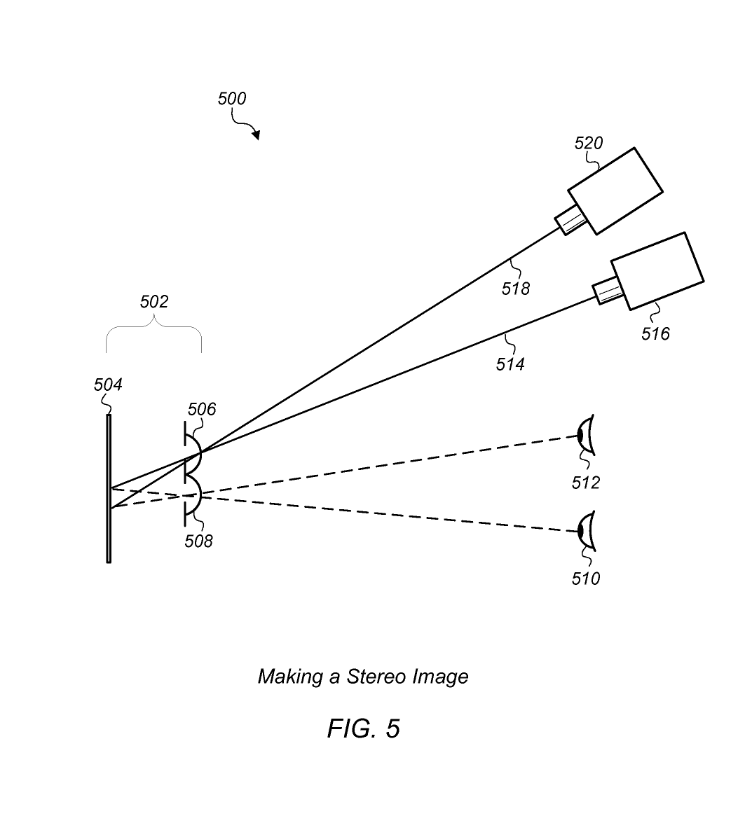

FIG. 5 illustrates an overlay display system 500 for providing a stereoscopic display, according to some embodiments. A stereoscopic surface 502 comprises a fluorescent layer 504 and a lens array comprising multiple lenses, including lens 506 and lens 508. The stereoscopic surface 502 may be applied to a surface, such as the UV absorption layer 106 or the glass 104 of FIG. 1.

In the example embodiment, lens array enables production of stereo images. In some embodiments, stereo images are produced at the expense of degrading the appearance of non-stereo images. The lens 506 and the lens 508 are adjacent lenses in an array of lenses that can included any number of additional lenses. A user observes images through a left eye 510 and a right eye 512. In some embodiments, the left eye 510 and the right eye 512 each observe a different part of the fluorescent layer 504 due to the lens 508 than if the lens 508 were absent. Similarly, the laser 514 from projector 516 and the laser 518 from projector 520 are each directed to a different part of the fluorescent layer 504 due to the lens 506 than if the lens 506 were absent. Based at least in part upon adjustment of the images scanned from the projector 516 and the projector 520 onto the fluorescent layer 504, different images may be produced for the left eye 510 and the right eye 512, enabling the formation of a stereo pair of images observed by the user. Thus, the user can observe a stereoscopic image. In some embodiments, the overlay display system 500 includes one or more sensing elements that track the location of the left eye 510 and the right eye 512 in order to determine which lasers should be activated for the projectors 516, 520 to produce an image for each eye of the user.

In some embodiments, one or more of the above embodiments of the overlay display system 500 are at least partially implemented by one or more control systems which are at least partially implemented by one or more computer systems. For example, in some embodiments a computer system includes a control system which controls the UV image projected by a projection system onto a fluorescent layer of a surface, such as a window, to control a graphical display overlay provided to a user, such as an occupant of a vehicle interior cabin.

### Methods of Providing an Overlay Display

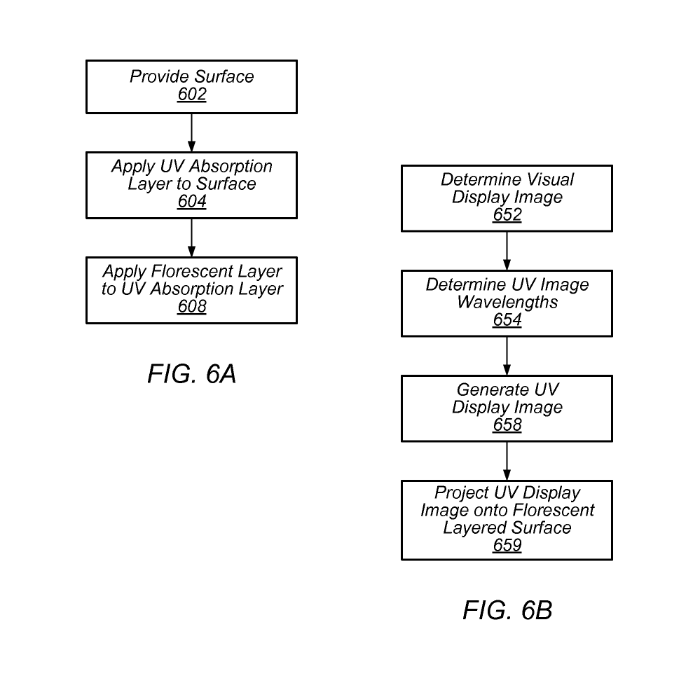

FIG. 6A illustrates a flowchart of a method for providing a surface configured to provide a graphical overlay display to a user based on a projected UV image onto the surface, according to some embodiments.

At 602, a surface is provided. The surface can include a transparent surface, such as a window. In some embodiments, the surface may be at least partially transparent. For example, in different embodiments, the surface may range from fully transparent to translucent for one or more light wavelengths, such as visible light. In some embodiments, the surface is at least partially opaque (e.g., semiopaque, semitransparent, partially transparent, translucent) to one or more light wavelengths, such as visible light. At 604 a UV absorption layer is applied to the surface. Such application can include layering a UV absorption film onto one or more sides of the surface. Such application can include layering a UV absorption film onto a particular surface of a window, including an interior surface. In some embodiments, the step at 604 is absent, and the surface provided at 602 is formulated to include one or more components configured to absorb UV light of one or more wavelengths. In some embodiments, the surface includes a layer of UV absorption material proximate to one or more particular sides of the surface. At 608, one or more fluorescent layers are applied to the surface, on a side of the surface which includes the applied UV absorption layer, such that the UV absorption layer is located between the one or more fluorescent layers and the surface itself, such that the fluorescent layers are located between the applied UV absorption layer and an external environment, some combination thereof, etc. The one or more fluorescent layers can each include one or more various phosphors configured to activate at one or more particular UV activation wavelengths. In some embodiments, multiple layers are applied at 608, where each separate layer includes a separate phosphor configured to activate at a separate UV wavelength.

FIG. 6B illustrates a flowchart of a method for providing a graphical overlay display to a user, according to some embodiments. The method can be implemented by one or more control systems, which can be implemented by one or more computer systems. At 652 a particular visual display image to be displayed in a graphic overlay is determined and/or generated. At 654 one or more sets of UV wavelengths corresponding to various visual wavelengths included in the visual display image are determined. The wavelengths can be determined based on a correlation between the visual wavelengths in the display image and activation wavelengths of one or more phosphors included in one or more fluorescent layers of a surface on which the overlay display is provided, where the one or more phosphors are configured to transmit light at the corresponding visual wavelength based on activation by UV light of the corresponding UV wavelength. At 656, based on the determined corresponding UV wavelengths for the visual wavelengths of the display image, a UV display image is generated. The generated UV display image includes the visual wavelengths of various elements of the display swapped for the corresponding UV wavelengths. At 658, the UV display image is projected onto at least a portion of a surface on which the one or more fluorescent layers are located, such that the phosphors located in the one or more layers are activated by the UV wavelengths of the UV display image and transmit light in the corresponding visual wavelength, such that the visual display image is presented via light transmitted from the fluorescent layer of the surface.

### Example Computer System

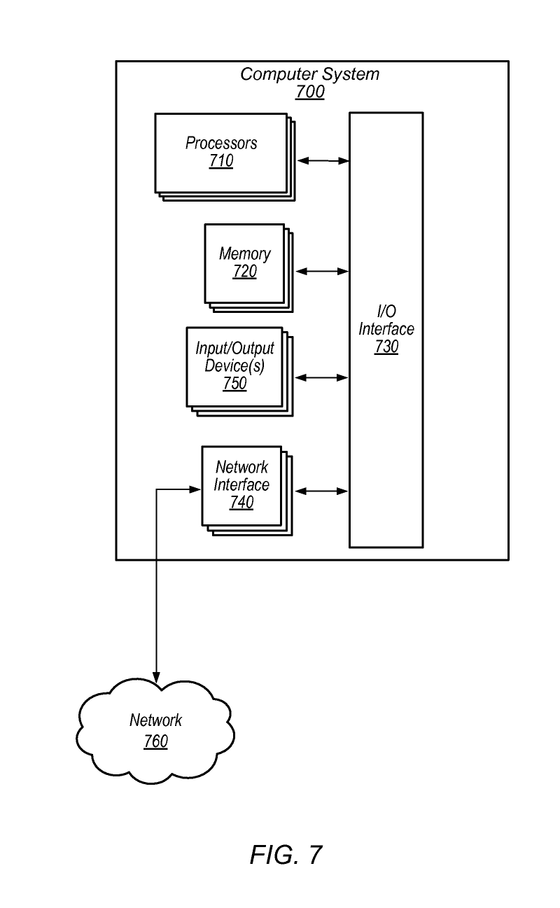

FIG. 7 illustrates an example computer system 700 that may be configured to include or execute any or all of the embodiments described above. In different embodiments, computer system 700 may be any of various types of devices, including, but not limited to, a personal computer system, desktop computer, laptop, notebook, tablet, slate, pad, or netbook computer, cell phone, smartphone, PDA, portable media device, mainframe computer system, handheld computer, workstation, network computer, a camera or video camera, a set top box, a mobile device, a consumer device, video game console, handheld video game device, application server, storage device, a television, a video recording device, a peripheral device such as a switch, modem, router, or in general any type of computing or electronic device.

Various embodiments of an overlay display system as described herein may be executed in one or more computer systems 700, which may interact with various other devices. Note that any component, action, or functionality described above with respect to FIGS. 1 through 6B may be implemented on one or more computers configured as computer system 700 of FIG. 7, according to various embodiments. In the illustrated embodiment, computer system 700 includes one or more processors 710 coupled to a system memory 720 via an input/output (I/O) interface 730. Computer system 700 further includes a network interface 740 coupled to I/O interface 730, and one or more input/output devices 750, such as a cursor control device, keyboard, and/or display(s). In some cases, it is contemplated that embodiments may be implemented using a single instance of computer system 700, while in other embodiments multiple such systems, or multiple nodes making up computer system 700, may be configured to host different portions or instances of embodiments. For example, in one embodiment some elements may be implemented via one or more nodes of computer system 700 that are distinct from those nodes implementing other elements.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs), such as the x85, PowerPC, SPARC, or MIPS ISAs, or any other suitable ISA. In multiprocessor systems, each of processors 710 may commonly, but not necessarily, implement the same ISA.

System memory 720 may be configured to store camera control program instructions and/or camera control data accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions of memory 720 may be configured to implement a lens control application incorporating any of the functionality described above. Additionally, program instructions of memory 720 may include any of the information or data structures described above. In some embodiments, program instructions and/or data may be received, sent or stored upon different types of computer-accessible media or on similar media separate from system memory 720 or computer system 700. While computer system 700 is described as implementing the functionality of functional blocks of previous Figures, any of the functionality described herein may be implemented via such a computer system.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network 760 (e.g., carrier or agent devices) or between nodes of computer system 700. Network 760 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

Memory 720 may include program instructions, which may be processor-executable to implement any element or action described above. In one embodiment, the program instructions may implement the methods described above. In other embodiments, different elements and data may be included. Note that data may include any data or information described above.

Those skilled in the art will appreciate that computer system 700 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A device, comprising:
a first layer configured to absorb ultraviolet light, wherein the first layer is at least partially transparent to visible light; and
a second layer configured to:
receive a first ultraviolet image; and
generate a first visual image based on the first ultraviolet image.

2. The device of claim 1, wherein:
one or more phosphors of the second layer react with the first ultraviolet image to generate the first visual image.

3. The device of claim 2, wherein:
the first ultraviolet image comprises a plurality of ultraviolet wavelengths;
a first phosphor of the second layer reacts with a first of the plurality of ultraviolet wavelengths to generate a first visual wavelength of the first visual image; and
a second phosphor of the second layer reacts with a second of the plurality of ultraviolet wavelengths to generate a second visual wavelength of the first visual image.

4. The device of claim 3, wherein:
the first layer is at least partially opaque to one or more light wavelengths.

5. The device of claim 3, wherein:
the second layer comprises at least a first phosphor layer and a second phosphor layer; and
the first phosphor layer comprises the first phosphor and the second phosphor layer comprises the second phosphor.

6. The device of claim 1, wherein:
the second layer is further configured to:
receive a second ultraviolet image; and
generate a second visual image based on the second ultraviolet image.

7. The device of claim 6, wherein:
a first projection field comprising the first visual image and a second projection field comprising the second visual image at least partially overlap.

8. The device of claim 7, wherein:
the first visual image and the second visual image are configured to be perceived by a user as a stereoscopic image.

9. The device of claim 8, wherein light from at least a portion of the first visual image is directed through a first lens of the device and light from at least a portion of the second visual image is directed through a second lens of the device.

10. A system, comprising:
a surface, comprising:
a first layer configured to absorb ultraviolet light; and
a second layer configured to:
receive a first ultraviolet image; and
generate a first visual image based on the first ultraviolet image;
a processor configured to:
determine a first visual image to be displayed;
determine one or more ultraviolet wavelengths that correspond to one or more visual wavelengths associated with the first visual image; and
generate the first ultraviolet image based on the one or more ultraviolet wavelengths; and
a first projector configured to:
project the first projection field comprising the first ultraviolet image onto the surface.

11. The system of claim 10, wherein at least a first phosphor of the second layer reacts with the first ultraviolet image to generate the first visual image.

12. The system of claim 11, further comprising a second projector configured to project a second projection field comprising a second ultraviolet image onto the surface, wherein at least a second phosphor of the second layer reacts with the second ultraviolet image to generate a second visual image.

13. The system of claim 12, further comprising a first camera and a second camera, wherein the processor is further configured to:
determine, based on input from the first camera and input from the second camera, an amount of overlap between the first projection field and the second projection field; and
adjust a position of at least one of the first projection field and the second projection field based on the amount of overlap.

14. The system of claim 12, further comprising a first camera and a second camera, wherein the processor is further configured to:
determine, based on input from the first camera and input from the second camera, an amount of distortion of the first ultraviolet image; and
adjust the first ultraviolet image based on the amount of distortion.

15. The system of claim 12, wherein the first visual image and the second visual image form a stereoscopic image.

16. A method, comprising:
absorbing ultraviolet light at a first layer of a surface;
receiving a first ultraviolet image at a second layer of the surface; and
generating a first visual image at the second layer of the surface based on the first ultraviolet image.

17. The method of claim 16, wherein the generating the first visual image comprises:
receiving, by a first phosphor of the second layer, a first ultraviolet wavelength; and
generating, by the first phosphor, a first visual wavelength that corresponds to the first ultraviolet wavelength.

18. The method of claim 17, wherein the generating the first visual image further comprises:
receiving, by a second phosphor of the second layer, a second ultraviolet wavelength; and
generating, by the second phosphor, a second visual wavelength that corresponds to the second ultraviolet wavelength.

19. The method of claim 16, further comprising:
receiving a second ultraviolet image at the second layer of the surface; and
generating a second visual image at the second layer of the surface based on the second ultraviolet image.

20. The method of claim 19, wherein the first visual image and the second visual image form a stereoscopic image.
